(19) United States
(12) Patent Application Publication
(10) Pub. No.: US 2026/0022026 A1
(43) Pub. Date: Jan. 22, 2026

(54) A METHOD FOR RECOVERING LITHIUM FROM A STREAM CONTAINING LITHIUM

(71) Applicant: METSO FINLAND OY, Espoo (FI)

(72) Inventors: Kaj Jansson, Espoo (FI); Eija Saari, Espoo (FI); Marika Tiihonen, Espoo (FI)

(73) Assignee: METSO FINLAND OY, Espoo (FI)

(21) Appl. No.: 19/106,496

(22) PCT Filed: Aug. 28, 2023
(86) PCT No.: PCT/FI2023/050490

§ 371 Date: Feb. 25, 2025

(30) Foreign Application Priority Data
Aug. 29, 2022 (FI) 20225757

(51) Int. Cl. C01F 7/043; C22B 3/12; C22B 3/22; C22B 7/00; C22B 26/12; H01M 10/54

(52) U.S. Cl. CPC C01F 7/043; C22B 3/12; C22B 3/22; C22B 7/008; C22B 26/12; H01M 10/54

(57) ABSTRACT

A method for recovering lithium from a stream containing lithium. The method includes the step of contacting the stream, or a pre-treated solution obtained from the stream, with an aluminium-containing material to form a precipitate including lithium aluminate, at an alkaline pH. The method further includes the step of recovering a slurry of the lithium aluminate.

### FIELD

The present invention relates to a method and arrangement for recovering lithium from a stream containing lithium, obtained by processing ores, brines or recycled material, such as battery waste material.

### BACKGROUND

Lithium (Li) is a metal used in batteries and currently the mining and processing of lithium is of great interest. The main sources of lithium include brines and ores, while recycling of various Li-containing materials, e.g. battery waste material, is also increasing.

Processes treating lithium-bearing mineral raw material, such as rocks, ores, clay or concentrates, usually involve first thermal treatment of these rocks at high temperature, followed by water leaching to release lithium values into solution. Brines are typically concentrated before further processing. The leach liquors or concentrated brines are then further treated using precipitation, ion exchange, etc., to remove residual contaminants. Carbonation using soda ash or carbon dioxide is preferred to precipitate lithium carbonate as the final product, whereas lithium hydroxide (LiOH) is frequently recovered via crystallization or electrodialysis, e.g. using bipolar membranes.

However, especially in the LiOH route, there will still be significant amounts of lithium left in the solution after crystallisation and removal of the main product as a solid, the remaining solution typically still containing around 30 g/l. One possible way to recover the remaining lithium from such solution is to use lithium carbonate and/or phosphate precipitation, which allows lowering the concentration of lithium in said solutions. When using a combination of carbonate and phosphate precipitation, a level of 250 mg/l can be achieved, which seems to be the lowest guaranteed level with this method. However, the current environmental concerns mean that even lower levels of lithium in the process effluent would be beneficial. Furthermore, effluents from lithium phosphate precipitation typically contain residual phosphate, which should not be released into nature.

Other existing technologies to treat effluents from lithium processing mainly consist on evaporation and crystallisation of the final waste and effluents. However, this method is known as very expensive, and the space required is much bigger than a simple precipitation process. Furthermore, evaporation and crystallisation may take a long time, which also increases the risk of leakage into nature, due to for example heavy rains. Ion exchange may also be used but has the disadvantage that the effluent may have other harmful components, such as chloride. Ettringite might also be possible to use, but is typically not even contemplated, since it creates a mixture of impurities in a sludge, the disposal of which is a further problem.

Document EP 963950 presents a method for preparing lamellar AlLiO2 by reaction of an aqueous solution issued from industrial ion exchanges on zeolites and containing at least one lithium salt with a solution of sodium aluminate and then separating the formed lamellar lithium aluminate at a pH of 6-13. However, this method requires a high-purity aqueous solution in order to be able to synthesize a pristine lamellar product.

There exists thus a need to provide a suitable method for lowering the amount of lithium in solutions containing lithium, to a level that is below 200 mg/l, suitable for use also with low-purity effluents, and without creating new problematic effluents or waste material. A further aim is to provide such a method which at the same time uses a minimum amount of materials not yet used in current methods. Preferably, the method would be usable in existing processes with existing equipment and still further, it would preferably help in both minimizing the usage of harmful chemicals, which may be used in other known processes, and avoiding any other harmful compounds in the final waste material and effluents. Further, such a method would maximize lithium recovery from common raw materials.

### SUMMARY

The invention is defined by the features of the independent claims. Some specific embodiments are defined in the dependent claims.

According to a first aspect, there is provided a method for recovering lithium from a stream containing lithium, the method comprising
contacting the stream, or a pre-treated solution obtained from said stream, with an aluminium (Al)-containing material, such as an Al-containing compound, an Al metal or an Al-containing alloy, or a mixture or combination of two or all three of these, as a coagulant, to form a precipitate comprising lithium aluminate (LiAlO2), at an alkaline pH; and
recovering a slurry comprising the lithium aluminate.

According to a second aspect, there is provided an arrangement for recovering lithium from a stream containing lithium, comprising
a flocculation and/or coagulation unit comprising means for adding an aluminium-containing material and means for recovering lithium aluminate formed in the unit.

According to a third aspect, there is provided a system for recovering lithium (Li), comprising
units for processing a Li-containing ore, brine or concentrate,
means for collecting liquid effluents from the processing units; and
an arrangement as described above, for recovering lithium from said liquid effluent(s).

### BRIEF DESCRIPTION OF THE DRAWINGS

FIG. 1 schematically illustrates one embodiment.

FIG. 2 schematically illustrates another embodiment.

FIG. 3 schematically illustrates another embodiment.

FIG. 4 schematically illustrates another embodiment.

### DETAILED DESCRIPTION

In the present context, the term “mineral” comprises materials obtained from the processing of metal-containing ores or rocks. The invention relates particularly to lithium-containing minerals, such as spodumene, petalite, lepidolite or zinnwaldite, or mixtures thereof. Any percentages are weight percentages (wt-%, weight/weight), unless otherwise specified. The term “stream” is used to describe any flow of material, either solid or liquid, preferably being an aqueous stream, such as a slurry, solution, filtrate or mass flow, and most suitably being an aqueous slurry or solution. The term “effluent” is used to indicate any liquid stream obtained from the process, which is typically further treated. The final liquid effluent of the method may also be called final wastewater.

The present invention relates to a method for recovering lithium from a stream containing lithium, the method comprising
contacting the stream, or a pre-treated solution obtained from said stream, with an aluminium (Al)-containing material, such as an Al-containing compound, an Al metal or an Al-containing alloy, or a mixture or combination of two or all three of these (to form a precipitate comprising lithium aluminate, at an alkaline pH; and
recovering a slurry comprising the lithium aluminate precipitate.

Optionally, the method can comprise also a solid/liquid separation step following the recovery of the slurry, thus recovering the lithium product as a precipitate. Alternatively, the product can be reacted further to another lithium product, or treated further, e.g. by washing and drying.

The alkaline pH is preferably a pH of 8-13.5, more preferably a range of >8 to 13, such as 8.1-13, 8.2-13 or 8.3-13, more preferably 8.5-13, and most suitably 9-13.

In an embodiment, the step of contacting with the aluminium-containing material can be carried out by electrochemical water treatment (EWT), preferably by electrocoagulation, to obtain a solution deprived of undesired solutes.

In an alternative embodiment, the EWT is used as a pre-treatment step or post-treatment step to the contacting step. As a pre-treatment step, it can be used either to reduce the content of undesired solutes of the Li-containing stream before Li precipitation, or to precipitate an initial fraction of Li. As a post-treatment step, it can be used either to reduce the content of undesired solutes of the lithium aluminate-containing slurry, or to precipitate a further fraction of Li.

The EWT is a technology used to treat aqueous streams to reduce the contents of undesired components therein, without the need for further chemical addition, by utilizing processes, such as electrodesinfection, electrochemical reduction, electrocoagulation, electroflotation, and electrodialysis. As mentioned above, electrocoagulation is a preferred alternative for use in the present invention.

The present invention thus provides a method for recovering lithium from a stream containing lithium, in view of providing a final liquid effluent that has a lithium content that fulfils the strictest environmental specifications. The content of lithium in this liquid effluent of the method may be as low as 10 mg/l (i.e. 10 ppm). An optimised method also removes aluminium from the stream, to the extent required by specifications. The method has the added advantages of, in the preferred embodiment, making use of the same reagents and products already used in the process of treating lithium-containing materials. The method thus also avoids any further harmful compounds in the final wastewater and other effluents. For example, when the liquid containing lithium already has a high pH, for example because sodium hydroxide is used in the process from which it is derived, there is no need to increase the pH for the recovery of lithium from the liquid, or only to a minor extent. Further, in case the streams contain aluminium, it can be removed by this same method.

Further, according to one preferred embodiment, the present method is usable with minimal or no changes to existing process equipment. Moreover, as presented below, the end product of the present method is usable as such in a further process or processes.

The present method may for example be used as a replacement of lithium phosphate precipitation and reaches a much lower concentration of lithium in the final liquid effluent (as is shown below in the Experimental part), as it would simply mean replacing the phosphate reagent to the aluminium reagent, and no other process updates would be needed. The known lithium phosphate precipitation methods can only achieve a lithium concentration of about 250 mg/l in the final wastewater, while residual phosphates typically also found in the final wastewater (which is in turn also undesirable). The reaction of the present invention by using an aluminium-containing material, does also not introduce to the final effluent any compounds that would be harmful, or unnecessary, since no new active compounds are added in the method.

A further advantage of the present method is that, when used to treat an effluent from a lithium recovery plant, an increased overall yield of lithium product is achieved. The combined lithium recovery can be 90%, or even higher.

A still further advantage of the present method, compared to traditional waste stream treatment (evaporation and crystallisation) is that it is significantly faster, does not require as much space, has less environmental risks and a lower investment and operation cost. Furthermore, the method does not result in the formation of any significant amounts of waste, as the ettringite process.

As stated above, the present method includes a step wherein the stream containing lithium, or a pre-treated solution obtained from said stream, is contacted with an aluminium-containing material to form a precipitate comprising lithium aluminate, i.e. the reaction is allowed to take place. The pH during this step is alkaline, preferably 8-13, and the reaction time is less than 1 h, such as 10-30 min. The reaction can be carried out at any suitable temperature, for example at a temperature of 0-100° C., preferably 0-90° C., and more preferably 50-90° C.

At the end of the process, the lithium aluminate which has formed by precipitation in the reaction is recovered, typically as a slurry. Indeed, lithium aluminate is insoluble in water. The lithium aluminate, or the slurry thereof, may be recovered for example by solid-liquid separation, such as sedimentation, flotation or filtration, or by evaporation. One exemplary recovery method is dissolved air flotation (DAF).

According to an embodiment, the aluminium-containing compound that may be used alone or as a combination with one or both of the Al metal or Al-containing alloy used as alternative Al sources, is an Al-containing compound selected from the group of compounds that are commonly used as a coagulant in water treatment, or a mixture of two or more compounds. Preferred embodiments use compounds selected from a group consisting of aluminium hydroxide, aluminium sulphate, aluminium and iron sulphate, aluminium nitrate, polyaluminium nitrate, polyaluminium sulphate, polyaluminium chloride, aluminium/ferric chloride, polyaluminium chloride silicate, sodium aluminium silicate, polyaluminium silicate sulfate and sodium aluminate. Particularly preferred compounds are sodium aluminate and aluminium hydroxide.

The electrocoagulation that may be used in the contacting step in the present method, or as a pre-treatment or post-treatment step, is known per se and is carried out using a metal electrode containing Al. Power is supplied to the metal electrode serving as anode-cathode. Material selection is based individually on water quality. The principle of operation is to destabilize dissolved pollutants charge and to produce flocs suitable for mechanical removal. Chemical handling is eliminated, though electrode material is still counted as a consumable. The settings of the electrocoagulation can be easily determined by a person skilled in the art, while an exemplary charge loading would be 73 MC/m3.

The present method may be used in the process as a main step for removing lithium from process streams, or it may be used after another step used for removing lithium from process effluents, as a polishing step. The decision typically depends on the amount of lithium in the process streams, the existing process equipment as well as the possibilities for further use of the lithium aluminate with reasonable costs. As stated above, the present method can be used even for streams and effluents containing high concentrations of impurities.

According to an embodiment, the stream containing lithium is an effluent from a lithium recovery plant. The lithium recovery plant may comprise high temperature conversion of lithium-containing ore and leaching with water, or treatment of brine or recycled material. When lithium is recovered from ore, the lithium recovery plant can for example comprise high temperature conversion of lithium-containing ore and leaching with water. Such conversion typically comprises
calcining the mineral in one or more calcination steps, resulting in a calcined material containing lithium;
pulping the calcined material into a slurry, preferably together with a leaching reagent in an aqueous solution;
water-leaching the formed slurry; and
separating lithium-containing solids in a solid-liquid separation step from a solution containing the leaching reagent.

The lithium-containing mineral is preferably selected from spodumene, petalite, lepidolite, or zinnwaldite, or mixtures thereof, more preferably being spodumene. When carrying out the calcination on the spodumene of the preferred option, it turns into the more soluble beta-spodumene (β-spodumene).

The liquid stream obtained from the solid-liquid separation step is preferably an alkaline solution, more preferably a solution having a pH of 8-11.5. As stated above, this solution contains one or more carbonates, preferably one or more alkali metal carbonates, such as sodium carbonate (Na2CO3).

However, the stream containing lithium, that is treated according to the present invention, can be obtained from any other industrial process, even if the stream to be treated contains high concentrations of impurities. Common impurities in such industrial lithium-containing streams include, but are not limited to, the ions and solutes of sodium (Na), calcium (Ca) or other alkaline earth metals, potassium (K), borates and carbonates. Other possible alternatives include soluble silica and silicate species, phosphates (also hydrogen phosphates) and fluoride (F—). Typically, silica/silicates, carbonate ions (CO32-), sodium ions (Na+) and potassium ions (K+) are present in the highest amounts. Minor metals that may be present include Arsenic (As), Vanadium (V), molybdenum (Mo), manganese (Mn) and iron (Fe). None of these prevent achieving the advantage, mentioned above, of the present invention, i.e. achieving a sufficiently low content of lithium in the resulting final effluent.

Moreover, an arrangement for recovering lithium from a stream containing lithium is provided, the arrangement comprising
a flocculation and/or coagulation unit, comprising means for adding an aluminium-containing material to the unit and means for recovering lithium aluminate formed in the unit.

Typically, the flocculation and/or coagulation unit also comprises an opening or means for measuring reaction conditions to enable control of the treatment conditions and dosing.

The flocculation and/or coagulation unit may alternatively be in the form of an electrochemical water treatment cell, such as an electrocoagulation cell, or such a cell can be positioned before or after the flocculation and/or coagulation unit (upstream or downstream from the flocculation and/or coagulation unit, connected either to its inlet or outlet).

In the alternative electrochemical water treatment cell, a liquid stream containing lithium is fed to the cell, and electrochemical water treatment is carried out, preferably using an Al plate as the Al-containing material, causing the precipitation of Li, resulting in a slurry or solution being obtained, which contains precipitated lithium aluminate and which is deprived of possible undesired solutes.

If the EWT is used as a pre-treatment option, the lithium-containing stream is fed to the EWT cell, and electrochemical water treatment is carried out using a metal plate, which preferably is an Al plate or an iron (Fe) plate, the former causing precipitation of a first fraction of Li and the latter causing the precipitation of undesired solutes instead of Li. The undesired solutes must then be separated from the obtained slurry. This EWT pre-treatment thus results in a slurry or solution being obtained, which is deprived of possible undesired solutes, and which, depending on the used plate metal, may also contain precipitated lithium aluminate. This slurry or solution is then fed to the flocculation and/or coagulation unit, in which an aluminium-containing material is also supplied. After the processing time, lithium aluminate is recovered from the flocculation and/or coagulation unit.

If the main flocculation and/or coagulation unit of this embodiment is also an EWT cell, then two EWT cells are used in series.

If the EWT is used as a post-treatment option, the lithium-containing stream is fed to the flocculation and/or coagulation unit, in which an aluminium-containing material is also supplied. After the processing time, lithium aluminate is recovered from the flocculation and/or coagulation unit as a slurry containing precipitated lithium aluminate. This slurry is then fed into an EWT cell, and electrochemical water treatment is carried out using a metal plate, which preferably is an Al plate or an iron (Fe) plate, the former causing the precipitation of a further fraction of Li as the aluminate, and the latter causing the precipitation of undesired solutes instead of Li. These undesired solutes are then separated from the slurry. This EWT post-treatment thus results in a slurry or solution being obtained, which, depending on the used plate metal, may be deprived of possible undesired solutes, and which contains precipitated lithium aluminate.

If the main flocculation and/or coagulation unit of this embodiment is also an EWT cell, then two EWT cells are used in series, as for the previous embodiment.

According to a further embodiment, the flocculation and/or coagulation unit, or the means thereof for recovering the lithium aluminate, is a dissolved air flotation unit. Any other type of flocculating reaction unit may also be used, but as the lithium aluminate precipitates formed in the reaction may be very small in size, it may be difficult to remove them by filtration. When using a dissolved air (or other gas) flotation unit, together with a coagulant (i.e. the aluminium-containing compound), the lithium aluminate precipitates can be scraped off the surface of the liquid, as is known in the art.

The present arrangement can be used in connection with any type of process, in which a liquid stream containing lithium is formed, either as a process stream or as a waste stream. According to a particularly advantageous embodiment, it is used in connection with a process wherein lithium-containing ore is calcined and leached using a leaching reagent, typically alkali-metal carbonates, such as sodium (Na) or potassium (K) carbonates.

Further, a system for recovering lithium is provided, the system comprising
units for processing a lithium-containing ore, brine or recycled waste material, such as battery waste material,
means for collecting liquid effluents from the processing units; and
an arrangement as described above, for recovering lithium from said effluent(s).

The embodiments and variants described above in connection with the method, use and/or apparatus apply mutatis mutandis to the system. The present system thus allows the production of commercial lithium products, such as lithium carbonate and lithium hydroxide, even as battery grade products, while reducing the amount of lithium in the industrial effluents of e.g. these production processes, or other processes, to a level that fulfils the strictest requirements. All the products from the system are usable for a purpose, and only water is either released or re-circulated into the system.

Both the apparatus and system described above can be automated as is known in the art, including any control and follow up of the efficiency of the process as well as the quality and quantity of products resulting from the various steps.

It is to be understood that the embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. In addition, various embodiments and examples of the present invention may be referred to herein along with alternatives for the various components thereof. It is understood that such embodiments, examples, and alternatives are not to be construed as de facto equivalents of one another but are to be considered as separate and autonomous representations of the present invention.

Furthermore, the described features, structures, or characteristics may be combined in any suitable manner in one or more embodiments. In this description, numerous specific details are provided to provide a thorough understanding of embodiments of the invention. One skilled in the relevant art will recognise, however, that the invention can be practiced without one or more of the specific details.

While the forgoing examples are illustrative of the principles in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting examples are intended merely to illustrate the advantages obtained with the embodiments of the present invention.

### DETAILED DESCRIPTION OF THE DRAWINGS

The enclosed Figures schematically illustrate some embodiments. The Figures are simplified, and the actual process contains various recycling conduits, electrical connections, purification systems for other products than the ones discussed below, etc. These are readily known to a person skilled in the art.

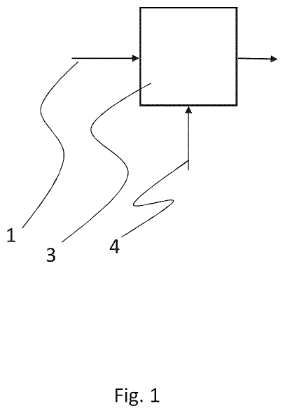

FIG. 1 schematically illustrates one embodiment. In this embodiment, a liquid stream 1 containing lithium is fed to a flocculation and/or coagulation unit 3, into which an aluminium-containing material 4 is also supplied. Lithium aluminate is recovered from the flocculation and/or coagulation unit.

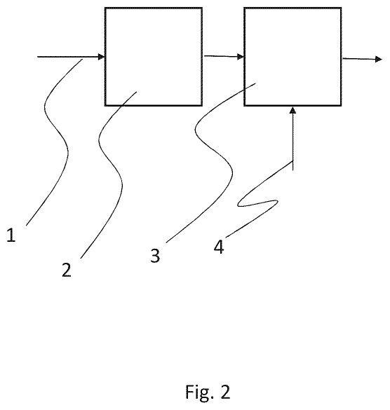

FIG. 2 schematically illustrates another embodiment. In this embodiment, liquid 1 containing lithium is fed into an electrochemical water treatment cell 2 to obtain a solution deprived of undesired solutes. The solution is fed to a flocculation and/or coagulation unit 3, into which an aluminium-containing compound 4 is also fed. Lithium aluminate is recovered from the flocculation and/or coagulation unit 3.

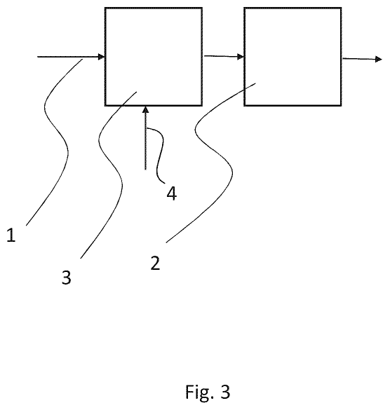

FIG. 3 schematically illustrates a further embodiment. In this embodiment, liquid 1 containing lithium is fed into a flocculation and/or coagulation unit 3, into which an aluminium-containing compound 4 is also fed. The obtained slurry is fed to an electrochemical water treatment cell 2, and lithium aluminate is recovered from the cell 2.

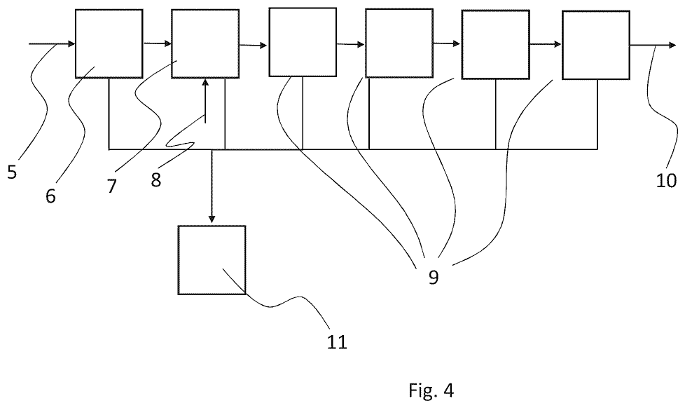

FIG. 4 schematically illustrates a fourth embodiment. In this embodiment, a treatment of lithium-containing ore is also illustrated. In a first step, lithium-containing ore 5 is fed to a heating unit 6, i.e. a high temperature conversion chamber, for calcination. The obtained calcined product is thereafter submitted to a pulping and leaching unit 7, for forming an aqueous slurry of the calcined product and for reacting the calcined product with a leaching reagent 8, such as an alkali metal carbonate. This leaching can be carried out under pressure. After further treatment units 9, which may comprise further leaching units, separation units, purification units, crystallization units and drying units, and optional parallel treatment units, such as gas cleaning units 9b, a pure lithium product 10 is obtained.

The liquid effluents from the further treatment units 9, and optionally from the main units 6,7, are collected and led to an apparatus 11 as described above. The apparatus 11 may be for example as described above in connection with any of FIGS. 1-3.

### EXPERIMENTAL SECTION

### Example 1

The present method was tested in a laboratory unit, with the aim of proving that it is possible to lower the amount of lithium in the solution down to 10 mg/l (i.e. 10 ppm). The experiment was thus not optimised, and it is believed that with some routine optimisation, even better results can be obtained. The effluent that was treated originated from a lithium phosphate precipitation stage in a manufacturing of battery grade lithium hydroxide. The effluent was carried to an electrocoagulation, but was tested both before and after the electrocoagulation for parameters such as pH, conductivity, redox and turbidity. The composition of the effluent was analysed by pre-filtering with a 0.45 μm syringe filter to remove any formed clogs.

The filtrated sample was analysed for dissolved components. Plasma Optical Emission Spectrometry (ICP-OES; ISO 11885) and Inductively Coupled Plasma Mass Spectrometry (ICP-MS; ISO 17294-2:2016) was used to analyze a set of 12 different elements namely As, Al, Ca, Cu, Mn, Mg, Fe, Ni, Li, Na, Si, P. Sulphate SO42- and chloride Cl— was analyzed by Ion chromatography (IC; ISO 10304-1:2017).

The effluent before electrocoagulation had a pH of 8.4-8.9, and a composition that is given in Table 1, TIC meaning total inorganic carbon.

TABLE 1

| Component | Dissolved |
|---|---|
| (mg/l) | concentration (mg/l) |
| As | 1.67 |
| Al | <0.05 |
| Ca | 1 |
| Cu | <0.05 |
| Mn | <0.01 |
| Mg | 0.1 |
| Fe | <0.01 |
| Ni | <0.01 |
| Li | 340 |
| Na | 7030 |
| Si | 197 |
| P | 340 |
| SO₄²⁻ | 205 |
| Cl⁻ | 8000 |
| TIC | 940 |

The effluent thus had a very small amount of metals, relatively high Li and P concentrations and elevated Na and Cl— content. Sulphate level remained around 200 mg/l. The effluent contained also approximately 940 mg/l of inorganic carbon.

The effluent was first treated in an equipment of electrocoagulation, with an initial pH of 5, Fe/Fe electrodes, a current density of 100 A/m2, a charge loading of 4 MC/m3 and a power consumption of 0.37 kWh/m3. The pH was adjusted with hydrochloric acid with a 30 minute retention time. The liquid was tested prior and after the electrocoagulation, and the results were as follows.

pH prior 5.11, after 6.27

Conductivity prior 30.4, after 32.6 mS/cm

Redox potential prior −282, after −210 mV

Turbidity prior 3.1, after >1000 FNU.

After the electrocoagulation, the effluent was submitted to dissolved air flotation (DAF), using 473 ppm of sodium aluminate (ALNA73™ by IQE) and 12 ppm of flocculant (Superfloc™ A100 by Kemira Oyj). After the DAF-treatment, the pH of the solution was 12.42, redox −185 mV, conductivity 51.2 mS/cm and turbidity 25.2 FNU.

The resulting liquid, after the flocculated material had been removed from the surface by scraping, was again analysed for its content and the results are given in Table 2, along with the analysis of the same content after EWT only.

TABLE 2

| | Dissolved | Dissolved |
|---|---|---|
| Component | concentration after | concentration after |
| (mg/l) | EWT (mg/l) | DAF (mg/l) |
| As | 0.6 | 0.6 |
| Al | <0.1 | 1840 |
| Mn | 0.03 | <0.01 |
| Mg | 0.09 | <0.05 |
| Fe | 17 | 0.01 |
| Ni | 0.1 | <0.01 |
| Li | 207 | 10 |
| Na | 6890 | 11400 |
| Si | 54 | 5 |
| P | 234 | 163 |
| SO₄²⁻ | 190 | 170 |
| TIC | 160 | 300 |

As can be seen, the amount of lithium in the final solution (final effluent) was only 10 mg/l, i.e. 10 ppm. Also the amount of some other components had been reduced. It can also be seen that the amount of sodium aluminate was slightly too high because the amount of aluminium remaining in the solution had increased. The increase in the amount of sodium also originates from the sodium aluminate.

The lithium, along with some other components, had thus precipitated as lithium aluminate and been retained by the flocs.

### Example 2

The present method was tested in a laboratory, with the aim of proving that it is possible to lower the amount of lithium in the solution down to ˜100 mg/l (i.e. 100 ppm). The experiment was thus not optimised, and it is believed that with some routine optimisation, even better results can be obtained. The effluent that was treated originated from the Metso Outotec LiOH Process for production of battery grade lithium hydroxide. Li recovery from the effluent was carried out by precipitation as lithium aluminate.

The effluent sample was analysed for dissolved components. Plasma Optical Emission Spectrometry (ICP-OES; ISO 11885) was used to analyze a set of 11 different elements namely Al, B, Ca, Fe, Li, Mg, Na, P, S, Si, Zn. The effluent used as feed solution in the test had pH of 10 and its chemical composition is given in Table 3.

TABLE 3

| Component | Dissolved |
|---|---|
| (mg/l) | concentration (mg/l) |
| Al | 3 |
| As | 2.9 |
| B | 74 |
| Ca | 64 |
| Fe | 1 |
| Li | 1760 |
| Mg | 1 |
| Na | 3590 |
| P | 5 |
| S | 20 |
| Si | 493 |
| Zn | <2 |

The effluent thus had low concentrations of metals, boron, phosphorus, and sulphur while the Li, Na and Si concentrations were relatively high.

The precipitation test was carried out in a glass beaker at ambient temperature. A sodium aluminate (NaAlO2) solution with 120 g/L concentration was prepared by dissolving solid technical grade anhydrous NaAlO2 in deionized water. Effluent was added to the beaker and agitation with a magnetic stirrer was started. NaAlO2 solution was added in the effluent so that the resulting molar Al/Li ratio was 2.3, after which a 30 min residence time followed. After residence time, a slurry sample was taken and filtered, and a solution sample was prepared from the filtrate for chemical analysis. The slurry pH was the adjusted with hydrochloric acid, after which a 30 min residence time followed. After residence time, a slurry sample was taken and filtered, and a solution sample was prepared from the filtrate for chemical analysis. The temperature and pH were measured at start and after the 30 min residence times of the NaAlO2 and HCl additions, and the results were as follows:

Starting temperature 23° C. and pH 10.1

30 min after NaAlO2 addition temperature 24° C. and pH 13.2

30 min after HCl addition temperature 25.4° C. and pH 12.1

The solution samples prepared from the filtrates after NaAlO2 and HCl additions were analysed for its content and the results are given in Table 4.

TABLE 4

| | Dissolved | Dissolved |
|---|---|---|
| | concentration after | concentration after |
| Component | NaAlO₂ addition | HCl addition |
| (mg/l) | (mg/l) | (mg/l) |
| Al | 1360 | 104 |
| As | 0.09 | <0.05 |
| B | 43 | 35 |
| Ca | 2 | 4 |
| Fe | <1 | <1 |
| Li | 266 | 117 |
| Mg | <2 | <2 |
| Na | 11600 | 10300 |
| P | <2 | <2 |
| S | 14 | 12 |
| Si | 6 | 2 |
| Zn | <1 | <1 |

As can be seen, the amount of lithium in the solution after NaAlO2 addition and pH adjustment with HCl was 117 mg/l, i.e. 117 ppm. Additionally, the amount of some other components, such as B, Ca, Fe, Mg, P, S, Si and As had been reduced. The increase in the amount of aluminium and sodium originates from the sodium aluminate.

The lithium, along with some other components, had thus precipitated as lithium aluminate and been retained in the solids.

1. A method for recovering lithium from a stream containing lithium, the method comprising:
contacting the stream, or a pre-treated solution obtained from said stream, with an aluminium-containing material selected from an aluminium-containing compound, aluminium metal or an aluminium-containing alloy, or a mixture or combination of two or all three of these, to form a precipitate comprising lithium aluminate, at an alkaline pH; and
recovering a slurry containing said lithium aluminate.

2. The method according to claim 1, wherein the step of contacting the stream or solution with an aluminium-containing material is carried out at a pH of 8-13.5, preferably from >8 to 13, such as 8.1-13, 8.2-13 or 8.3-13, more preferably 8.5-13, and most suitably 9-13.

3. The method according to claim 1, wherein the step of contacting the stream or solution with an aluminium-containing material is carried out at a temperature of 0-100° C., preferably 0-90° C., and more preferably 50-90° C.

4. The method according to claim 1, wherein the aluminium-containing material comprises or consists of an aluminium-containing compound, selected from a group consisting of aluminium hydroxide, aluminium sulphate, aluminium and iron sulphate, aluminium nitrate, polyaluminium nitrate, polyaluminium sulphate, polyaluminium chloride, aluminium/ferric chloride, polyaluminium chloride silicate, sodium aluminium silicate, polyaluminium silicate sulfate and sodium aluminate.

5. The method according to claim 1, wherein the stream containing lithium is a stream containing one or more of the ions of sodium (Na⁺), calcium (Ca²⁺) or potassium (K⁺), borates, carbonates, soluble silica and silicate species, phosphates (also hydrogen phosphates) and fluoride (F⁻) as impurities.

6. The method according to claim 1, wherein the stream containing lithium is an industrial stream, preferably being a stream from a lithium recovery plant.

7. The method according to claim 6, wherein the lithium recovery plant comprises high temperature conversion of lithium-containing ore and leaching with water, treatment of brine, or recovery of lithium from recycled materials, such as battery waste materials.

8. The method according to claim 6, wherein the lithium-containing ore is selected from ores comprising lithium-containing minerals, such as spodumene, petalite, lepidolite or zinnwaldite, or mixtures thereof.

9. The method according to claim 1, wherein the slurry containing the lithium aluminate is recovered by solid/liquid separation.

10. The method according to claim 1, wherein a pre-treatment or a post-treatment is carried out on the stream containing lithium or on the slurry comprising the lithium aluminate, respectively, the pre-treatment or post-treatment involving electrochemical water treatment, preferably being electrocoagulation, intended to provide a pre-treated or post-treated solution deprived of undesired solutes.

11. An arrangement for recovering lithium from a stream containing lithium, comprising:
a flocculation and/or coagulation unit comprising means for adding an aluminium-containing compound and means for recovering lithium aluminate formed in the vessel.

12. The arrangement according to claim 11, further comprising an electrochemical treatment cell, preferably being an electrocoagulation cell, connected to an inlet or an outlet of the flocculation and/or coagulation unit, being suitable for pre-treating the stream containing lithium before feeding it to the flocculation and/or coagulation unit, or post-treating a slurry obtained from the flocculation and/or coagulation unit.

13. The arrangement according to claim 11, wherein the flocculation and/or coagulation unit is an electrochemical treatment cell, preferably an electrocoagulation cell.

14. A system for recovering lithium, comprising:
units for processing a lithium-containing ore, brine or recycled material,
means for collecting liquid effluents from the processing units; and
an arrangement according to claim 11 for recovering lithium from said liquid effluent(s).

15. The system according to claim 14, wherein the units for processing a lithium-containing ore, brine or recycled material comprise
a heating unit for calcining lithium-containing ore;
a pulping and leaching unit for forming an aqueous slurry of the calcined product and for reacting the calcined product with a leaching reagent;
further treatment units; and
a first product recovery unit.
